(19) United States
(12) Patent Application Publication
(10) Pub. No.: US 2011/0193790 A1
(43) Pub. Date: Aug. 11, 2011

(54) TOUCH PANEL MODULE WITH ILLUMINATION FUNCTION

(76) Inventor: Teh-Zheng Lin, Taoyuan (TW)

(21) Appl. No.: 12/703,789

(22) Filed: Feb. 11, 2010

(51) Int. Cl. G06F 3/041; G09F 13/04

(52) U.S. Cl. 345/173; 362/97.1

(57) ABSTRACT

A touch panel module with illumination function, comprises a transparent touch panel; a light guiding plate being a transparent thin plate; one surface of the light guiding plate overlapping with the touch panel; another surface of the light guiding plate being formed with a light guiding structure; and peripheral walls of the light guiding plate being formed with light reflecting layers; one light reflecting layer being formed with a light projection hole; and at least one light source installed near the light projection hole.

### FIELD OF THE INVENTION

The present invention relates to touch panels, and in particular to a touch panel module with lower illumination function which is suitable for being installed before a display screen without any backlight source.

### BACKGROUND OF THE INVENTION

Current power saving electronic devices, such as E-books, E-papers, E-inks, etc. of low power consumption, are widely used. For matching the requirement of environment protection, these devices are light, thin and have small sizes. Power displays are also power saved, namely, no backlight module is provided. However, as they are used in dark areas or low illumination areas, the user can not view the images on the screens, while this makes trouble to users.

### SUMMARY OF THE INVENTION

The object of the present invention is to provide a touch panel module with illumination function, which can be used with power saving modules for providing illumination to the module. Thus, the touch panel module can be used in low illumination areas. Furthermore, it provides a low power light source, and thus it can be used with power saving electronic devices so as to reduce the power consumption of the electronic devices to make the requirement of environment protection.

To achieve above object, the present invention provides a touch panel module with illumination function, comprising: a transparent touch panel; a light guiding plate being a transparent thin plate; one surface of the light guiding plate overlapping with the touch panel; another surface of the light guiding plate being formed with a light guiding structure; and peripheral walls of the light guiding plate being formed with light reflecting layers; one light reflecting layer being formed with a light projection hole; at least one light source installed near the light projection hole. The touch panel is one of a resistive touch panel, a capacitive touch panel, an optical touch panel, a sonic wave touch panel, an electromagnetic touch panel and a compound form touch panel. The light guiding plate is thin plate with material selected from one of a glass, polycarbonate, polyester, polymethylmethacrylate, and ring olefin copolymer. The light reflecting layer is a mirror surface with high light reflecting ratio. The light source is an LED. The light guiding structure is protruding tips, lines or surfaces or textures. The light guiding structure is concave tips, lines or surfaces or textures.

Moreover, the present invention provides a touch panel module with illumination function, comprising: a touch sensor, a transparent touch layer; and a transparent substrate; where the touch sensor is installed between the touch layer and the substrate; the touch sensor, touch layer and the substrate are stuck together; where one surface of the substrate is installed with a light guiding structure; and peripheral wall of the substrate is installed with light reflecting layer; at least one light reflecting layer is formed with a light projection hole; and at least one light source is installed at an external side of the light projection hole. Furthermore, the light reflecting layer is a mirror surface with high light reflecting ratio. The light source is an LED. The light guiding structure is protruding tips, lines or surfaces or textures. The light guiding structure is concave tips, lines or surfaces or textures.

The reflection layer is silver or aluminum high reflectivity mirror layer. The reflecting layer is formed by electroplating, metal sputtering, printing, or adhering.

The light source is a middle or low power light source, preferably, it is LEDs, such as red LED, blue LED, green LED, or while LED.

The various objects and advantages of the present invention will be more readily understood from the following detailed description when read in conjunction with the appended drawing.

### BRIEF DESCRIPTION OF THE DRAWINGS

FIG. 1 is a lateral cross sectional view of the present invention.

FIG. 2 is an enlarged view about the part A of FIG. 1.

FIG. 3 is a lateral partial cross sectional view of another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to con fine the scope and spirit of the present invention defined in the appended claims.

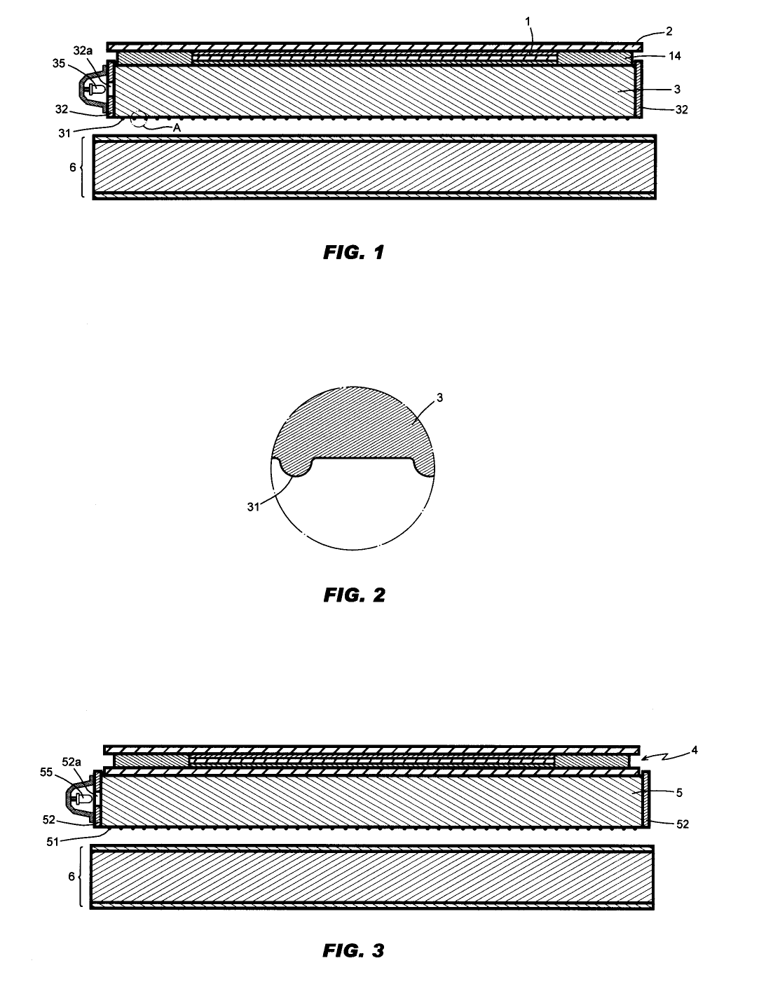

Referring to FIG. 1, the touch panel module with light source according to the present invention includes a touch sensor 1, a film layer 2 and a substrate 3. The touch sensor 1 is installed between the film layer 2 and the substrate 3. An outer periphery thereof is installed with a sticky frame 14 for combining the substrate 3 and the film layer 2. In this embodiment, the touch sensor 1 is a capacitive sensor which has a structure as the prior art one. Thus the details of the sensor will not be further described herein. The film layer 2 is a transparent polyethylene terephthalate (PET) film layer. The substrate 3 is a transparent thin plate made of polymethyl methacrylate (PMMA). A lower surface of the substrate 3 is formed with a plurality of small protrusions 31 (as illustrated in FIG. 2). End walls of the substrate 3 is grounded as smooth surfaces and are formed with silver reflecting surfaces 32. One of the reflecting surfaces 32 is opened as a light projection hole 32a. An LED (light emitting diode) 35 is installed at an outer side of the light projection hole 32a. Light emitting from the LED 35 can incident into the light projection hole 32a to the substrate 3. The LED 35 is further connected to a power switch (not shown) for switching the LED 35.

Above mentioned touch panel module can be installed in front of a display screen 6 of a power saving display, such as E-book, E-paper, and E-ink, etc. so that the protrusions 31 of the substrate 3 faces to the display screen 6 (referring to FIG. 1). When light from the LED 35 passes through the light projection hole 32a to the substrate 3, by the reflecting layer 32, the light from the substrate 3 will not disperse from the end walls. By the protrusions 31 of the substrate 3, the light can be guided to the display screen 6 for illumination. The protrusions 31 are distributed on the lower surface of the substrate 3 with a lower density. Thus they do not affect the image of the display screen.

FIG. 3 shows another embodiment of the present invention. In this the present invention, a prior art transparent touch panel 4 is overlapped upon the light guided plate 5. The light guided plate 5 is a transparent plate and a lower surface thereof is distributed with a plurality of transparent small protrusions 51. End walls of the light guiding plate are ground as smooth surfaces and are formed with reflecting layers 52. One reflecting layer 52 is opened with a light reflecting hole 52a and is installed with an LED 35 at an external side thereof. Thereby the prior art touch panel can be directly installed to the light guiding plate 5.

In above embodiment, the substrate 3 or the light guiding plate 5 may be formed with pits, or grooves, or textures, or formed as slender texture shapes, etc. for replacing the protrusions. All these are within the scope of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A touch panel module with illumination function, comprising:
a transparent touch panel;
a light guiding plate being a transparent thin plate; one surface of the light guiding plate overlapping with the touch panel; another surface of the light guiding plate being formed with a light guiding structure; and peripheral walls of the light guiding plate being formed with light reflecting layers; one light reflecting layer being formed with a light projection hole; and
at least one light source installed near the light projection hole.

2. The touch panel module as claimed in claim 1, wherein the touch panel is one of a resistive touch panel, a capacitive touch panel, an optical touch panel, a sonic wave touch panel, an electromagnetic touch panel and a compound form touch panel.

3. The touch panel module as claimed in claim 1, wherein the light guiding plate is thin plate with material selected from one of glass, polycarbonate, polyester, polymethylmethacrylate, and ring olefin copolymer.

4. The touch panel module as claimed in claim 1, wherein the light reflecting layer is a mirror surface with high light reflecting ratio.

5. The touch panel module as claimed in claim 1, wherein the light source is an LED.

6. The touch panel module as claimed in claim 1, wherein the light guiding structure is protruding tips, lines or surfaces or textures.

7. The touch panel module as claimed in claim 1, wherein the light guiding structure is concave tips, lines or surfaces or textures.

8. The touch panel module with illumination function, comprising:
a touch sensor,
a transparent touch layer; and
a transparent substrate;
where the touch sensor is installed between the touch layer and the substrate; the touch sensor, touch layer and the substrate are glued together;
where one surface of the substrate is installed with a light guiding structure; and peripheral walls of the substrate are installed with light reflecting layers; at least one light reflecting layer is formed with a light projection hole; and at least one light source is installed at an external side of the light projection hole.

9. The touch panel module as claimed in claim 8, wherein the light reflecting layer is a mirror surface with high light reflecting ratio.

10. The touch panel module as claimed in claim 8, wherein the light source is an LED.

11. The touch panel module as claimed in claim 8, wherein the light guiding structure is protruding tips, lines or surfaces or textures.

12. The touch panel module as claimed in claim 8, wherein the light guiding structure is concave tips, lines or surfaces or textures.
